(19) United States
(12) Patent Application Publication
(10) Pub. No.: US 2019/0073473 A1
(43) Pub. Date: Mar. 7, 2019

(54) DYNAMIC SECURITY DOMAIN DATA FLOW ANALYSIS VIA PASSIVE MONITORING

(71) Applicant: DornerWorks, Ltd., Grand Rapids, MI (US)

(72) Inventor: Steven H. VanderLeest, Grand Rapids, MI (US)

(21) Appl. No.: 15/693,579

(22) Filed: Sep. 1, 2017

(51) Int. Cl. G06F 21/55; G06F 21/62

(52) U.S. Cl. CPC G06F 21/554; G06F 2221/034; G06F 21/6218

(57) ABSTRACT

A system and method for dynamic security domain data protection through passive monitoring of data storage. The present invention may be implemented using data breakpoints to trigger invocation of the data flow analysis routines. A data breakpoint register may be associated with the memory location of each item of target data. Upon attempted access, a data breakpoint interrupt is triggered, which pauses execution and runs data flow analysis and security routines to determine the appropriate action. The present invention may be implemented using a virtual paging system having a memory management unit configured to generate a page fault upon any attempt to access target data. The virtual paging system may have a virtual page that contains target data and that page may be actively managed so that each attempted access to target data results in a page fault, which pauses execution and runs data flow analysis routines to determine appropriate action.

### BACKGROUND OF THE INVENTION

The present invention relates to systems and methods for protecting data in a computing system and, more particularly, to detecting and preventing the unauthorized use of data in a secure domain.

Detecting illicit use of data is important. Corrupted/untested data that is used within a sensitive computing environment can cause harm. Leakage of sensitive data to an unprotected computing environment can also cause harm. Sensitive data includes any information that could be used to cause harm if not kept secret. Sensitive data that must be kept secret includes personal information, such as health records or credit card numbers. It includes corporate proprietary information such as recipes, trade secrets, or customer lists. It includes government secrets, such as classified information.

Sensitive information on a computer should only be visible to authorized users, and if the sensitive information is communicated outside of the computer, it should only be transmitted to authorized users, usually by encrypting the information so that if the message is intercepted by an unauthorized user, the sensitive information cannot be obtained without the encryption key.

One means to ensure sensitive information is not leaked to unauthorized users is data flow analysis. This analysis documents where particular information moves within a computer, including when and where it enters or leaves. Data flow analysis can thus determine whether data crosses defined boundaries where it might be vulnerable to unauthorized access.

In a computer system running multiple software programs, a boundary is defined around the sensitive data, along with the programs that use the sensitive data, called a secure domain. Such systems are sometimes termed Multi-Level Security (MLS) systems because they contain information at different levels of security, associated with users authorized for varying levels of access. When information moves between domains, this is called a Cross Domain Transfer. In the Bell-LaPadula model of information security, these transfers are only allowed from domains of lower security to domains of higher security. Sometimes this strict one-way flow is not practical, and thus mechanisms are added to ensure data flowing from higher to lower security domains is not sensitive. This can be accomplished, for example, by means of data guards that scrub sensitive information before transfer, or by use of data flow analysis to flag and prevent unauthorized transfers.

Data flow analysis determines whether sensitive data inside the secure domain ever moves outside of the domain. It can also determine whether tainted data from outside the secure domain moves inside the domain (where it might corrupt the sensitive data). Thus, just as a network firewall prevents unwanted data from crossing from one network to another, data flow analysis can prevent data on one computer from crossing from one domain to another.

Static data flow analysis is performed on the software source code before it actually runs on the live system. Static data flow analysis of source code can identify all the possible means by which data flows through a system, but is often inexact (resulting in many false alarms) because the specific inputs and stimulus that occur at runtime are not yet known, so generally all possible inputs must be considered. Software languages that allow pointers can generate many additional paths in the analysis because the precise value of the pointer cannot be determined a priori, so every possible value of the pointer must be included in the analysis. This makes static analysis extremely time-consuming and often intractable. That is, a working system that doesn't have the potential for leakage cannot be found, even if in practice no leakage would actually occur.

Dynamic data flow analysis is performed on the software while it runs on the live system. A dynamic approach to detecting illicit use of data that is performed during the actual execution of the software can be precise (reducing or eliminating false alarms), because it is monitoring the actual usage of the data, rather than trying to predict it based on a simple static analysis. For example, the exact value of each input and each pointer is known at run time and available to dynamic analysis, but is not known before run time and thus static analysis must consider all possible values.

The most common dynamic approach is called taint analysis. Most taint analysis is focused on preventing corrupted or compromised data from entering the system. That is, it attempts to prevent intrusion (infiltration), as illustrated in FIG. 1. Usually upon detecting use of tainted data, the system is halted or an alarm is sounded. Any data that is combined with the tainted data is also marked as tainted because it might now be corrupted, so the set of data that must be monitored might grow over time.

Besides using data flow analysis to detect data intrusion, it can also be used to detect data extrusion (or exfiltration), where sensitive or secure data leaks out of the secure domain. Any data that is combined with sensitive data must also be considered sensitive, so the set of data that must be monitored might grow over time. Dynamic data flow analysis to prevent sensitive data extrusion must allow use of the sensitive data to continue as long as the data stays within the boundaries of the defined secure domain, but it must flag a warning or halt the system if sensitive data might be transferred outside the domain (FIG. 2), such as through an unauthorized interface to another system or an unauthorized external communication. The techniques of taint analysis to detect intrusion by marking the tainted (bad) data could also be used to detect extrusion by instead marking the sensitive (good) data.

Conventional forms of taint analysis (1) mark or label the tainted data in some way (either by extension data fields or by a separate list) and then (2) monitor-by-instruction for use of the tainted data on each and every execution of instructions, potentially updating the list of tainted data based on the result of the executed instruction. The monitoring step can be performed in several ways. For example, the software source code for each program handling the data of interest (either the tainted/bad or sensitive/good data) can be modified to insert additional instructions that handle the marking and following of the data. Another method does not modify the source code, but instead stops the execution of the program step by step (FIG. 3), executing the marking and monitoring instruction each time.

Regardless of the particular method, the monitoring step is an active and perturbing measurement, i.e., it modifies the system under measurement in order to take the measurement. This type of active measurement can result in undesirable changes to the underlying behavior of the system, particularly if the system is timing-sensitive or performance-sensitive.

### SUMMARY OF THE INVENTION

The present invention provides a system and method for dynamic security domain data protection through passive monitoring of data storage. For sensitive data present in a security domain, this may include monitoring for any attempt to access (read or write) to the storage location for the sensitive data (or target data). Any attempted access to target data may trigger a validation mechanism that performs a data flow analysis and then determines whether to allow the access. For unauthorized data introduced into the secure domain, this may include monitoring for any effort to write new data to a storage location in the secure domain. Any attempt to write new data may invoke a data classification mechanism through which the new data may be designated as target data, if appropriate. Once designated as target data, the new data will become subject to passive monitoring and, once triggered, subject to the validation mechanism.

The present invention may be implemented in a wide range of computer systems in which data flow into or out of a secure domain is possible. For example, the computer system may be a multilevel security computer system having a number of domains with different security profiles. The computer system may include a single computer or a plurality of computers operatively interconnected using essentially any network structure, including local or remote networking.

In one embodiment, the system generally includes a computer, data storage capable of storing target data designated as sensitive and a mechanism for monitoring attempted access to target data contained in data storage. The monitoring mechanism may recognize when access to target data is attempted and invoke data flow analysis routines that determine whether or not to permit access. “Access” may include any attempt to read or write to the data location of an item of target data. The computer system may be a multi-level system with at least one secure domain containing target data. The monitoring mechanism may be configured to manage exfiltration of target data out of the secure domain and/or to manage infiltration of data into the secure domain. The present invention may be implemented using data breakpoints (also known as “data watchpoints”) to trigger invocation of the data flow analysis routines. In embodiments of this type, the computer system may have a processor with one or more data breakpoints that result in an interrupt when access to a data breakpoint is attempted. The processor is configured to assign a data breakpoint to each memory location of the target data. When access to the target data is attempted, the processor generates a data breakpoint interrupt and invokes the validation mechanism. For example, the interrupt handler may be configured to run data flow analysis routines to determine the precise movement of data in the system and then determine the appropriate action based on that data flow. If the access is permitted, the interrupt handler returns to the normal execution flow, allowing the paused instruction to complete its attempt to access the data. If the access is not permitted, the offending operation is halted. Optionally, various alarm notifications can be made.

The present invention may additionally or alternatively be implemented using a virtual paging system having a memory management unit configured to generate an interrupt in the form of a page fault upon any attempt to access a page that is not in main memory or is not configured with access permissions. In one embodiment, the virtual paging system may have a virtual page or plurality of virtual pages that contain target data. Upon occurrence of a page fault, the system may run a page fault handler configured to determine if the page fault is associated with a virtual page containing target data. If so, the page fault handle may initiate the validation analysis mechanism, for example, by running data flow analysis routines to determine the appropriate action. The system may be configured so that each attempted access to target data results in a page fault, which may include soft/minor page faults and/or hard/major page faults. Accordingly, the processor may be configured to remove the virtual page from main memory after each access or to keep the virtual page in main memory but remove user access privilege to the page after each access. Upon a detected access, if the validation mechanism determines the access is permitted, the access permissions for the page are changed to permit the access and the instruction is allowed to continue, competing its access. The validation mechanism may also add to the target data list if the data flow analysis indicates new target data has been generated.

In one embodiment, the system uses interrupts (hardware or software) to invoke the data flow analysis mechanism. For example, the system may be configured so that an interrupt is triggered when access to target data is attempted (read or write). In one embodiment, the interrupt is established in the form of a data breakpoint (also known as a conditional breakpoint or watchpoint). The target data may be stored in memory and any attempt to access the associated memory location for read or write purposes may trigger the data breakpoint. The interrupt handler for the data breakpoint may invoke the validation mechanism. The interrupt handler returns to the interrupted flow of instructions only if the access is permitted.

In an alternative embodiment, the target data may be stored using virtual memory and the interrupt may be established in the form of a page fault. With this alternative, the target data may be stored in a virtual page, and any attempt to access the associated virtual page for read or write purposes may result in a page fault that triggers a hardware exception. The exception handler may determine whether the page fault was triggered by efforts to access a page containing target data and, if so, invoke the data flow analysis mechanism. In this embodiment, the exception handler may be configured to take action to ensure that any subsequent access to the target data results in the page fault. This may be achieved by removing the page from memory after each use, which will result in a major page fault and require the page to be reloaded into memory at each use. Alternatively, the user access privileges for that page in the memory management unit may be removed, which will result in a minor page fault and simply require the access permissions for that page in the MMU to be changed without the need to reload the page. In some applications, the system may use a combination of data breakpoints and virtual paging. For example, the system may use data breakpoints to monitor target data until the number of data breakpoint registers is exhausted. When all of the data breakpoint registers are in use, additional items of target data may be stored using the virtual paging system and the virtual paging monitoring mechanism described above.

The present invention may be combined with essentially any validation mechanism that includes a data flow analysis mechanism that is capable of determining where data is moving for a particular operation and includes an approval mechanism that is capable of determining whether a particular attempt to access target data should be permitted. For example, the data flow analysis mechanism may be a software application or other arrangement of code that is configured to analyze the circumstances surrounding the attempted data access to determine whether it is legitimate or illicit. This may include interrogation of the security level of the application attempting to obtain access, the identity of the user running the application, the action to be taken with the target data and essentially any other factors of potential interest. If the attempted access is determined to be legitimate, the data flow analysis mechanism may allow access to the target data. If it is illicit, the data flow analysis mechanism may prohibit access to the target data and may implement other security measures, such as halting operation of the offending application and issuing a message to system security personnel. Examples of some data flow analysis methods that may be incorporated into the present invention include: control flow analysis, available expression analysis, parse tree analysis, interprocedural analysis, definite assignment analysis. For example, the approval mechanism may be a simple security policy implementation that authorizes movement of data into or within a security domain but prohibits movement of data out of the security domain. Approval could also be determined based on subsets of data, the content of the data, the amount of data moved within a given time period, or more complex behaviors.

In one embodiment, the system maintains a list of target data. The list may be kept segregated or otherwise secured so that applications cannot maliciously change it. The list of target data may include sensitive data that is identified at initialization. Additional sensitive data may be identified and added to the target data list during operation in realtime. For example, sensitive data received as input to the system during run time can be added to the target data list. As another example, new data that is dependent upon or otherwise provides any information regarding target data may be added to the target data list. To prevent unnecessary growth in the list of target data, the system may also be configured to remove target data from the list of sensitive data when appropriate. This may occur when an item of target data is overwritten with non-sensitive data, for example, when an item of sensitive data is no longer needed or no longer valid.

Although data breakpoints and page faults are exemplary mechanisms for implementing the present invention, the present invention may be implemented using other hardware mechanisms. For example, in one alternative embodiment, the system may include a logic analyzer or bus analyzer that is connected to an interface bus within the computer system to analyze data across that bus. The logic analyzer or bus analyzer may monitor activity on the interface bus and trigger action when communications involving an address associated with target data is found on the address bus. In one embodiment, the logic analyzer may be configured to initiate an interrupt signal to the monitored computer system. For example, the computer system may be configured such that there is an interrupt handler associated with the logic analyzer that can be initiated by the logic analyzer when an attempted access to target data is recognized. As another example, the logic analyzer may be configured to trigger an interrupt associated with a different system component or different system event, such as a device driver, or attempting to access a data location associated with a data breakpoint register for the purpose of causing a data breakpoint interrupt. These mechanisms can be used to pause execution of the current instruction and to invoke a handler or other routine that invokes the validation mechanism when access to target data is recognized.

In another aspect, the present invention provides a method to detect and prevent unauthorized data movement on a computing system in which data flow analysis is initiated when access (read or write) to sensitive data is attempted. In one embodiment, the method includes the general steps of: (a) identify the data of interest (target data), (b) establishing monitoring of all target data, (c) invoking the validation mechanism upon each attempted access to target data. The validation mechanism consists of (i) data flow analysis to determine the precise nature of the movement of data for the current operation and (ii) permitting or preventing access depending on the outcome of the data flow analysis mechanism. The method may also include the step of updating or otherwise affecting the list of target data in response to the data flow analysis mechanism. For example, when the operation attempting access to target data will propagate the target data or otherwise result in new sensitive data, the data is added to the target list. As another example, when the operation will result in the elimination of target data, the eliminated target data is removed from the target list.

In one embodiment, the step of identifying the data of interest includes building a list of target data. This may include a list of all sensitive data that is in within the program data section at initialization and/or a list of the memory locations associated with all sensitive data. Sensitive data input into the system or otherwise arising after initialization, for example, during run time, is added to the target list. As another example, sensitive data may be combined with other data, and the derived result is then considered sensitive and added to the target list.

In one embodiment, the step of establishing monitoring of all target data includes the step of assigning a separate data breakpoint or data breakpoint register to each memory location containing target data. In embodiments of this type, the step of invoking the validation mechanism includes the steps of (a) triggering a data breakpoint interrupt upon attempted access to the target data, (b) invoking an interrupt handler in response to the data breakpoint interrupt, and (c) running data flow analysis routines to determine the movement of data, run approval routines to determine whether to permit or prohibit access, and if access permitted, also identify any new target data resulting from the access.

In one embodiment, the step of establishing monitoring of all target data includes the steps of: (a) assigning each item of target data to one or more virtual pages, (b) affecting memory or the memory management unit to ensure a page fault is triggered by access to any target data contained on any virtual page, (c) invoking a page fault interrupt handler in response to the page fault, (d) determining if the page fault relates to attempted access to a target data and (e) upon a determination that the page fault is related to attempted access to target data, running validation routines to determine whether to permit or prohibit access.

In another embodiment, the step of establishing monitoring of all target data includes the steps of: (a) operatively coupling a logic analyzer to an interface bus, (b) monitoring via the logic analyzer for attempted access to a memory location containing target data, (c) implementing an event when access to target data is attempted and (d) in response to the event, running validation routines to determine whether to permit or prohibit access.

In another embodiment, the step of establishing monitoring of all target data includes the steps of: (a) operatively coupling bus analyzer logic to an interface bus within a System On Chip (SoC), (b) monitoring via the bus analyzer for attempted access to a memory location containing target data, (c) interrupting the SoC processor when access to target data is attempted and (d) in response to the interrupt, running validation routines to determine whether to permit or prohibit access.

The present invention provides a simple and effective system and method for protecting sensitive data with reduced impact on system performance. The present invention detects and prevents unauthorized data movement on a computing system with minimal perturbation to the running software. By passively monitoring data flow using data watching hardware mechanisms, such as data breakpoints, page faults or logic, it can detect and prevent unauthorized flow of untrusted data into a secure domain defined on the system and can also detect and prevent unauthorized flow of secret or sensitive data out of a secure domain. Any data derived from the target data can also be monitored for unauthorized flow.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 is a block diagram of a conventional computer system implementing a taint analysis routine.

FIG. 2 is a block diagram of a conventional system implementing a data leakage routine.

FIG. 3 is a flow chart illustrating a conventional data flow analysis method that implements an instruction-by-instruction approach.

FIG. 4 is a flow chart illustrating a passive monitoring approach in accordance with an embodiment of the present invention.

FIG. 5 is a block diagram of a computer system in accordance with an embodiment of the present invention.

FIG. 6 is a block diagram of a computer system in accordance with an embodiment of the present invention.

FIG. 7 is a block diagram of a computer system in accordance with an embodiment of the present invention.

FIG. 8 is a flow chart of a method in accordance with an embodiment of the present invention.

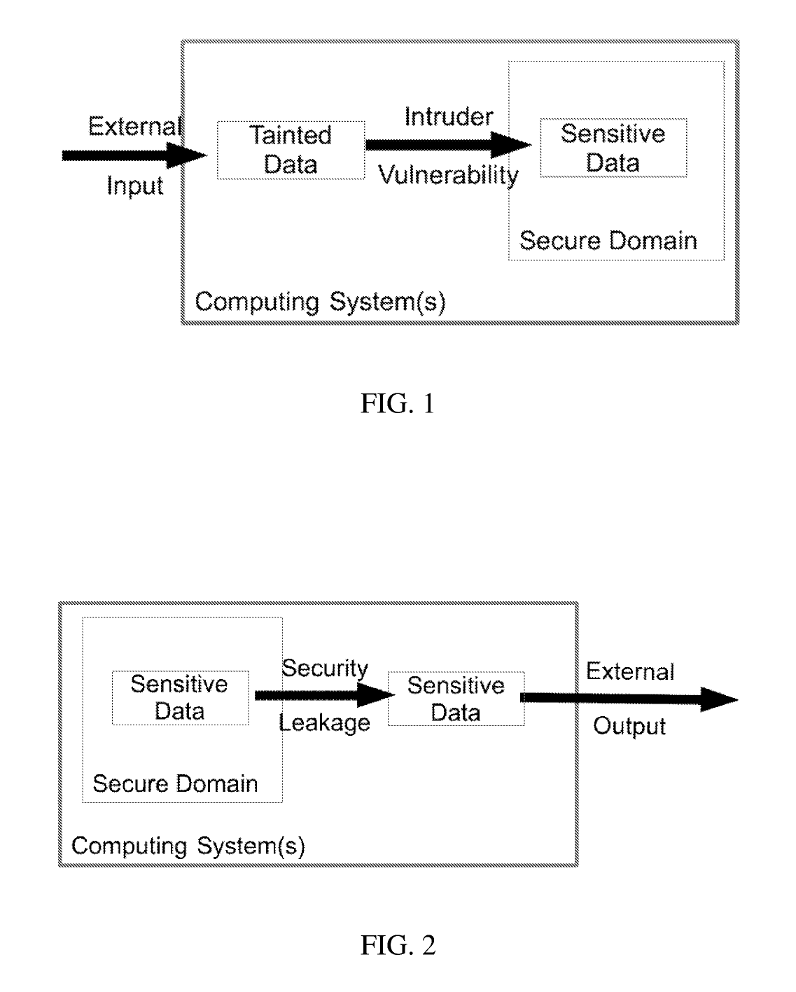

### DESCRIPTION OF THE CURRENT EMBODIMENT

Overview.

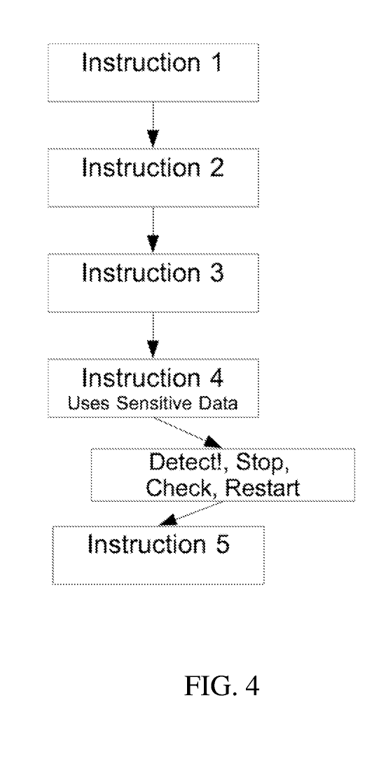

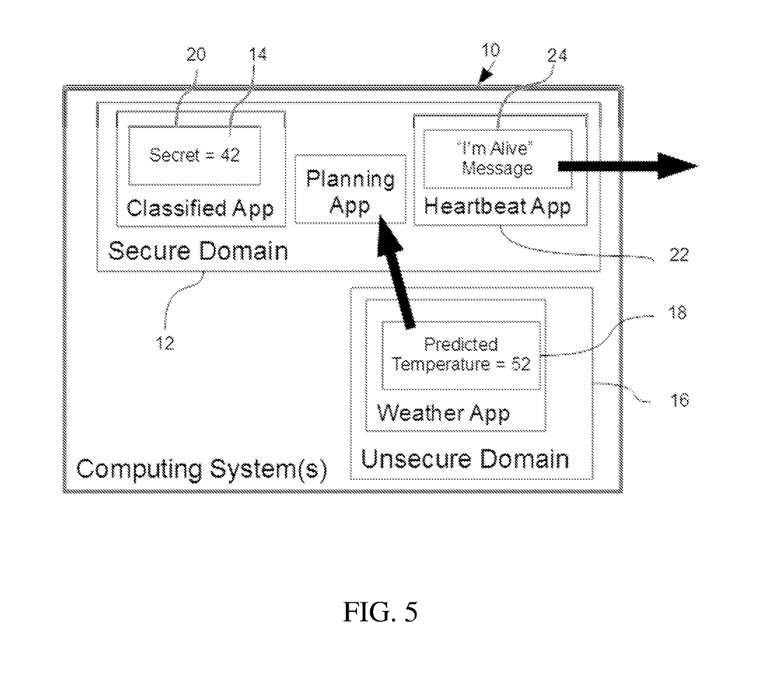

A system for detecting and preventing unauthorized data movement on a computing system is shown in FIG. 5. In the illustrated embodiment, the computing system 10 is a Multi-Level Security system (MLS) that generally includes a variety of domains, including at least one secure domain 12 with storage 14 that contains target data, and an architecture that makes possible cross domain transfer of information, such as between secure domain 12 and unsecure domain 16. Instead of analyzing each instruction, the present invention includes hardware or software mechanisms that monitor for access to target data in data storage, and only invoke validation analysis when access to target data is recognized. For example, as shown in FIG. 4, the present invention may invoke validation analysis only when it is determined upon initiation of Instruction 4 there is attempting to access sensitive data (e.g., target data). No validation analysis is performed for Instruction 1, Instruction 2, Instruction 3 or Instruction 5. The monitoring mechanism may monitor for attempts to read from or write to a memory location associated with target data. The system may maintain a dynamic list of target data, including sensitive data that is present at the start of an application and new target data that is generated or received during runtime. The monitoring mechanism may be configured to recognize any attempted access to any target data, and then invoke validation analysis with regard to that attempt to determine whether or not to allow the attempted access. In the illustrated embodiment, the monitoring mechanism may be implemented using data breakpoints. For example, each item of target data may be associated with a data breakpoint. When access to the target data is attempted, a data breakpoint interrupt occurs and the interrupt handler invokes the validation analysis mechanism to determine whether or not to permit access. The present invention may additionally or alternatively be implemented using a virtual paging system. With this approach, the target data may be stored in a virtual page that is not mapped for access. When any access to target data is attempted, the memory management unit generates a page fault interrupt. The page fault interrupt handler is configured to determine if the page fault is associated with a virtual page containing target data. If so, the page fault handle may initiate the validation analysis mechanism. The system may use any validation mechanism, which may include essentially any data flow analysis to determine data movement and any approval mechanism to determine whether to permit access. For example, the approval mechanism may be configured to permit access from an application having appropriate security, and deny access from an application that does not. The system may also be configured to add and/or remove target data during runtime. For example, data derived from existing target data could be considered new target data, or data arriving on certain input ports could be considered new target data. This functionality may be implemented as part of the data flow analysis or as a separate routine that is triggered by the attempted access.

Passive Monitoring of Data Storage.

As noted above, the present invention provides a system and method for providing dynamic security domain data protection through passive monitoring of data storage. The system may be configured to protect against exfiltration of sensitive data and/or infiltration of untrusted (or “tainted”) data. For sensitive data (or target data) present in a security domain, this may include monitoring for any attempted access to the storage location for the target data. Any attempted access to target data may result in invocation of a validation analysis mechanism that determines whether to allow the access. For untrusted or unauthorized data introduced into the secure domain, this may include monitoring for any effort to write new data to a storage location in the secure domain. Any attempt to write new data may invoke a data classification mechanism through which the new data may be designated as target data, if appropriate. Once designated as target data, the new data will become subject to passive monitoring and to the data flow analysis mechanism. Data introduced from an untrusted source may also be classified as unauthorized or corrupted data and prohibited from writing to the secure domain.

The present invention may be implemented in a wide range of computer systems having essentially any architecture that includes hardware to detect access to certain data, including, but not limited to data breakpoint registers, data watchpoint registers, or a virtual memory system. The present invention may be particularly useful in applications in which data flow into or out of a secure domain is possible. For example, the computer system may be a multi-level security (“MLS”) computer system having a number of domains with different security profiles. The implementation of the present invention may differ depending on the general and/or specific architecture of the computer system, as well as other relevant factors. The computer system may be implemented in a portion of a single computer, a single computer or a plurality of computers operatively interconnected using essentially any network structure, including local or remote networking. The system may include one or more CPUs, one or more CPU cores of a multicore processor or plurality of multicore processors. The system may include an FPGA or ASIC containing one or more CPU cores and associated logic. The system may include memory for storing data. The memory type may vary from application to application, and may include volatile and/or non-volatile memory types. For example, the system may include one or more of the following types of memory (either internal or externally mounted): RAM, SRAM, DRAM, ROM, EEPROM, Flash and/or NVRAM, as well as mechanical storage devices, such as hard disk drives, as well as externally mounted drives such as USB or SD cards. The memory may have a single port or multiport architecture. In some embodiments, the system may include Direct Memory Access (DMA) devices, which have the ability to read from or write to addresses where data is stored. For example, the system may include one or more I/O devices that have DMA capability. In those embodiments that incorporate multiport memory, the system is configured to accommodate and monitor any of these components that access data stored in a multiport memory by any port, using any address that is associated with the target data. In the illustrated embodiment, the present invention may be implemented as executable instructions integrated into any system component or set of components, including, for example, a CPU and a hardware device. The executable instructions may be implemented in any number of separate routines that are called or executed as appropriate to implement the present invention.

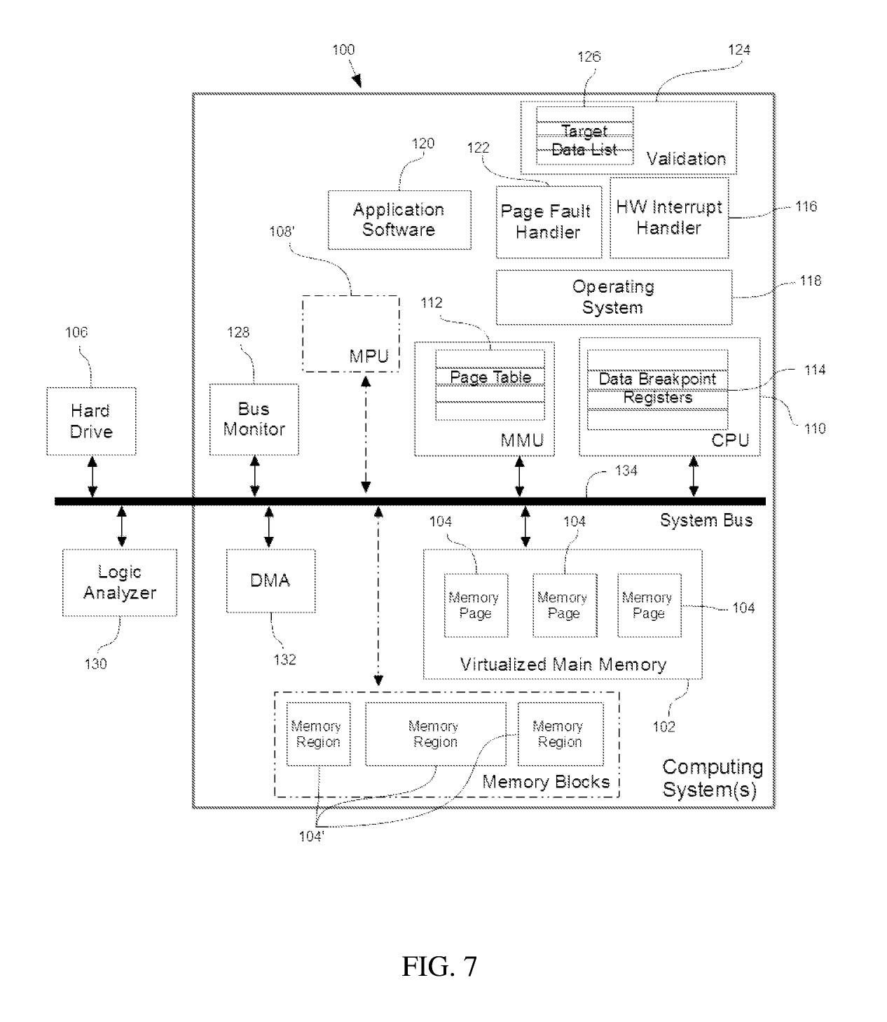

For purposes of disclosure, the present invention is described in connection with the multi-level security computing system shown in FIG. 7. In this embodiment, the computing system 100 generally includes a single computer or a collection of networked computers that are arranged to provide the computing system 100. In this embodiment, the system 100 generally includes a computer system, data storage capable of storing target data and a mechanism for monitoring attempted access to target data contained in data storage. The computing system 100 may include one or central processing units, such as CPU 110, to provide centralized or distributed control over the system. Although the CPU 110 is illustrated as a single block, the computing system 100 may include one or more CPUs and the number, arrangement and architecture of the CPU or CPUs may vary from application to application as desired. For example, system operations may be carried out by a single CPU or by a collection of CPU that individually perform portions of the system operations. The CPU 110 (or CPUs) may include data break point registers 114 that are configured to generate an interrupt when there is an attempt to access any data location stored in one of the data breakpoint registers. The number of data breakpoint registers 114 may vary from application to application. The computing system 100 may also include an interrupt handler 116 to manage and control responses to interrupts, such as a data breakpoint interrupt. The interrupt handler may be implemented as a block of programming code configured to cause the system 100 to carry out the desired response to interrupts. The computing system 100 may run essentially any operating system or number of operating systems. For example, as shown in FIG. 7, the computing system 100 may run operating system 118. The computing system 100 may run essentially any number of software applications, as exemplified by application software 120. The computing system 100 may include essentially any form of data storage. For example, the computing system 100 may include a virtual memory system having a memory management unit (MMU) 108 that control operation of a virtualized main memory 102 with exemplary memory pages 104. As illustrated in FIG. 7, the MMU 108 may include a page table 112 that stores the mapping between virtual addresses and physical address. The computing system 100 may also include a page fault handler 122 to provide the system with instructions for responding to a page fault interrupt. In the context of the present invention, the page fault handler 122 may initiate the validation mechanism 124. As an alternative or in addition to virtual memory, the system 100 may implement a memory segmentation system. In such applications, the system 100 may have memory blocks 102′ with exemplary memory regions 104′. The system 100 may also include a memory protection unit (MPU) 108′ to manage and control access to memory. The MPU 108′ may be configured to initiate an interrupt upon any attempt to access sensitive data (target data). The interrupt handler 116 may configured to invoke the validation mechanism 124 upon the occurrence of an interrupt initiated by the MPU 108′. The data storage may also include additional storage, such as high capacity storage, which in FIG. 7 is provided as hard drive 106. To assist in implementing the present invention, the computing system 100 may include a validation mechanism that evaluates data flow (read, write or any form of direct or indirect access to sensitive data) within the system and determines whether to permit data flow and whether supplemental action is required in response to data flow. With regard to the system 100 shown in FIG. 7, the computing system 100 may include a validation mechanism 124 having data flow analysis routines and security routines. The validation mechanism 124 may include a target data list 126 that directly or indirectly identifies all of the sensitive data (or the memory addresses of all of the sensitive data in the system. The computing system 100 may also include a bus monitoring device, such as a bus monitor 128 and or a logic analyzer 130 connected to the system bus 134. The bus monitor 128 and/or logic analyzer 130 can be used to monitor for and initiate an interrupt when an effort to access the memory location of an item of sensitive data appears on the system bus 134. This may include the ability to determine when a direct memory access device (DMA), such as DMA 132 shown in FIG. 7, is attempting to access sensitive data.

The monitoring mechanism may recognize when access to target data is attempted and invoke validation analysis routines that determine whether or not to permit access. In this embodiment, “access” may include any attempt to read from or write to the data location of an item of target data. The term “access” is not limited to attempts to read from or write to the data location of target data, but may include any effort to directly or indirectly obtain information from or about any item of target data or to directly or indirectly write, change or otherwise taint the system or any target data within the system. The computer system may be a multi-level system with at least one secure domain containing target data. In this embodiment, the monitoring mechanism is configured to detect exfiltration of target data out of the secure domain and to detect infiltration of data into the secure domain, but it may be desirable in some application to implement only exfiltration detection or only infiltration detection. Although described above as a multi-level security computer system, the present invention may be incorporated into other types of computing systems, such as computing systems with a single domain or computing systems with a number of domains without security restrictions between them. For example, the computing system may include a single secure domain in which internal data flow is generally unrestricted, except with respect to the potential propagation of taint. As another example, the system may include a number of domain in which data flow between the domains is unrestricted, except with respect to the potential propagation of taint. In these types of applications, the primary objectives of the system may be to detect and address infiltration (and taint) and exfiltration with respect to the system as a whole and not with respect to different domains within the system. As a result, a computing system with at least one secure domain is intended, for purposes of this disclosure, to include any system with a single domain or a plurality of domains even if there are generally no restrictions on the flow of data within the computing system.

In the illustrated embodiment, the system maintains a list of target data. The list of target data may include sensitive data that is identified at initialization. Additional sensitive data may be identified and added to the target data list during operation in realtime. For example, sensitive data received as input to the system during run time can be added to the target data list. As another example, new data that is dependent upon, derived from, or otherwise provides any information regarding target data may be added to the target data list. To prevent unnecessary growth in the list of target data, the system may also be configured to remove target data from the list of sensitive data when appropriate. This may occur when an item of target data is overwritten with non-sensitive data, for example, when an item of sensitive data is no longer needed or no longer valid.

The present invention is intended to broadly encompass any monitoring mechanism that is capable of recognizing and pausing any attempt to access target data. The monitoring mechanism may be implemented using a hardware mechanism. In the illustrated embodiment, the system may use interrupts (hardware or software) to invoke the validation mechanism. For example, the system may be configured so that an interrupt is triggered when access to target data is attempted (read or write). More specifically, the target data may be stored in memory and any attempt to access the associated memory location for read or write purposes may trigger the data breakpoint. In one embodiment, an interrupt is established in the form of a data breakpoint (also known as a conditional breakpoint or watchpoint). A number of commercially available processors or CPUs are provided with a plurality of data breakpoint registers. In a typical processor, each data breakpoint register is capable of being assigned to or associated with a specific location, or range of locations, in memory. In this embodiment, the memory location of each item of target data may be associated with a separate data breakpoint or data breakpoint register. When access to that memory location is attempted, an interrupt is triggered by the hardware. Upon occurrence of the data breakpoint interrupt, an interrupt handler may be invoked. The interrupt handler may, in turn, initiate validation analysis with respect to the attempted access to target data. The validation analysis may include data flow analysis and security analysis. For purposes of this disclosure, “security analysis” is intended to broadly encompass any approval, authentication, security policy, or any other type of analysis that can help determine whether a given access should be permitted and whether additional action should be taken required in response to the access. A wide variety of routines for implementing data flow analysis and security analysis are known to those skilled in the field, and therefore will not be described in detail. In the illustrated embodiment, the validation analysis is carried out by a validation mechanism that is implemented as a set of routines integrated into the interrupt handler and/or a set of routines separate from the interrupt handler that are invoked by the interrupt handler. More specifically, the validation mechanism of the illustrated embodiment generally includes two sets of routines: (1) data flow analysis routines that evaluate the instruction that is being executed to determine the associated data flow and (2) security analysis routines that determine whether to allow the instruction to execute and whether to take additional action in response to execution of the instruction. The validation mechanism may be implemented using essentially any desired combination of data flow analysis routine(s) and security analysis routine(s).

Data breakpoints are only one possible mechanism for monitoring attempted access to target data. In some computer systems, there may not be a sufficient number of data breakpoints to provide monitoring of all items of target data. In these systems, the present invention may be implemented using a memory management system, such as a memory protection or virtual paging solution (or a combination of data breakpoints and memory protection and virtual paging). For purposes of this disclosure, the term memory management system is intended to broadly encompass any memory management system in which memory is segmented and interrupts are generated in response to certain attempts to access select memory segments, such as a memory protection implementation or a virtual memory implementation. In applications of this nature, the present invention may additionally or alternatively be implemented using a virtual paging system having a memory management unit configured to generate an interrupt in the form of a page fault upon any attempt to access a page that is not in memory. With this alternative, the target data may be maintained in a virtual page or plurality of virtual pages, and any attempt to access a virtual page containing target data (for read or write purposes) is configured to result in a page fault that triggers a hardware exception. Alternatively, instead of virtual pages, a processor may provide access permissions to protect regions of memory. In this case, the target data may be maintained in certain regions of memory, and any attempt to access those regions results in a permission fault (also sometimes referred to as a “segmentation fault”) that triggers a hardware exception. The exception handler may determine whether the page or permission fault was triggered by efforts to access a page or region containing target data and, if so, invoke the validation analysis mechanism. In this embodiment, the exception handler may be configured to take action to ensure that any subsequent access to the target data results in the page or permission fault. This may be achieved in a virtual memory implementation by removing the page from memory after each use, which will result in a major page fault and require the page to be reloaded into memory at each permitted use. Alternatively, the entry for that page in the page table of the memory management unit may be modified to remove access permissions, which will result in a minor page fault and simply require the entry for that page in the MMU to be rewritten to permit access without the need to reload the page itself. In a memory protection implementation, the permission or access rights for any memory block containing target data may be set so that a permission fault or segmentation fault is triggered by any attempted access to that memory block. For example, the memory protection unit may be configured to set the permission or access rights so that no user or application has permission to access any memory block that contains target data. The present invention may be implemented with different strategies for storing target data. In some applications, all target data may be stored in one or more memory blocks dedicated to target data. In other applications, target data may be intermingled in memory blocks with non-sensitive data. Although generally feasible, the later approach may require more frequent invocation of the validation mechanism.

In some applications, the system may use a combination of data breakpoints and either virtual paging or memory region protections. For example, the system may use data breakpoints to monitor target data until the number of data breakpoint registers is exhausted. When all of the data breakpoint registers are in use, additional items of target data may be stored using the virtual paging system and the virtual paging monitoring mechanism described above, or may be stored using any system the processor provides to enforce access permissions to different regions of memory.

Although data breakpoints and page faults are exemplary mechanisms for implementing the present invention, the present invention may be implemented using other hardware or software mechanisms. For example, in one alternative embodiment, the system may include a logic analyzer, a bus monitor or other bus monitoring device that is connected to an interface bus within the computer system to analyze data across that bus. The bus monitoring device (e.g., logic analyzer or bus monitor) may monitor activity on the interface bus and trigger action when communications involving an address associated with target data is found on the address bus. In one embodiment, the logic analyzer may be configured to initiate a hardware or software interrupt. For example, the computer system may be configured such that there is an interrupt associated with a signal from the logic analyzer that can be triggered by the logic analyzer when an attempted access to target data is recognized. As another example, the logic analyzer may be configured to trigger an interrupt associated with a different system component, such as an I/O device, or different system event, such as a communication port. To illustrate, the logic analyzer may be configured to initiate an interrupt using the processor external interrupt signal causing an external interrupt, which in turn invokes the external interrupt handler. The handler is then configured to invoke validation analysis routines. These various mechanisms can be used to pause execution of the current instruction and to invoke a handler or other routine that invokes the validation analysis mechanism when attempted access to target data is recognized.

The present invention may be combined with essentially any validation analysis mechanism that is capable of determining whether a particular effort to access target data should be permitted. For example, the validation analysis mechanism may be a software application or other arrangement of code that is configured to analyze the circumstances surrounding the attempted data access to determine whether it is legitimate or illicit. This may include data flow analysis, such as an evaluation of the domain from which the data is being accessed or the action to be taken with the target data. This may include interrogation of the security level of the application attempting to obtain access, the identity of the user running the application, and essentially any other factors of potential interest. If the attempted access is determined to be legitimate, the validation analysis mechanism may allow access to the target data and allow the paused instruction that is attempting the access to continue. If it is illicit, the validation analysis mechanism may prohibit access to the target data and may implement other security measures, such as halting operation of the offending application and issuing a message to system security personnel. Some examples of data flow analysis methodologies that may be implemented by the present invention include: control flow analysis, available expression analysis, parse tree analysis, interprocedural analysis, definite assignment analysis. Some examples of approval analysis methodologies that may be implemented by the present invention include a simple security policy implementation that authorizes movement of data into or within a security domain but prohibits movement of data out of the security domain. Approval could also be determined based on subsets of data, the content of the data, the amount of data moved within a given time period, or more complex behaviors.

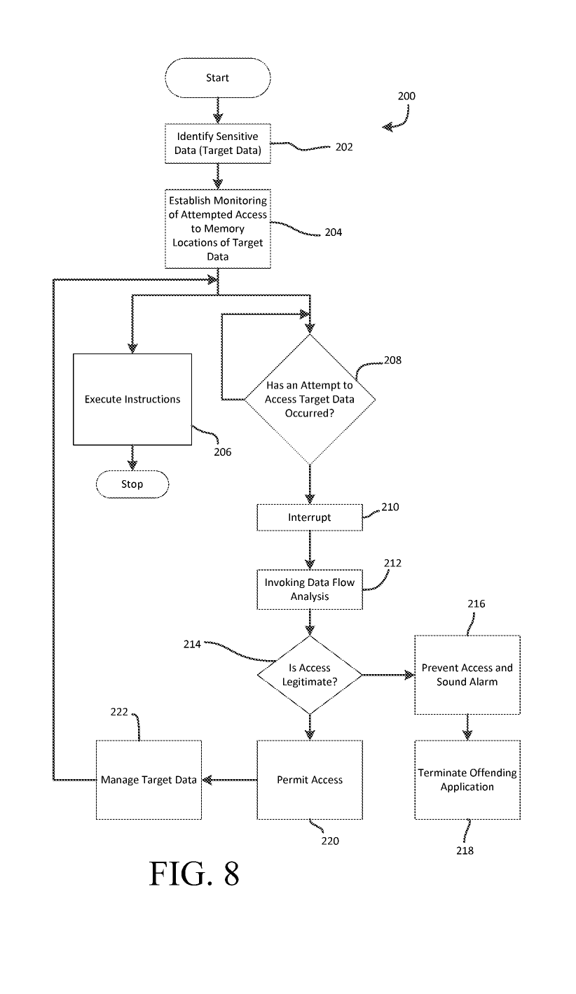

In another aspect, the present invention provides a method to detect and prevent unauthorized data movement on a computing system in which data flow analysis is initiated when access (read or write) to sensitive data is attempted. In one embodiment, the method includes the general steps of: (a) identify the data of interest (target data), (b) establishing monitoring of memory locations for all target data, (c) invoking the validation analysis mechanism upon each attempted access to a memory location of target data and (d) permitting or preventing access to the target data depending on the outcome of the validation analysis mechanism. The method may also include the step of managing target data in response to the data flow analysis performed as part of the validation analysis mechanism. For example, when the operation attempting access to target data will propagate the target data or otherwise result in new sensitive data, the data is identified as new target data and becomes the subject of monitoring. As another example, when the operation will result in the elimination of target data, the eliminated target data is removed as target data and no longer monitored. For example, FIG. 8 shows the general steps of a method 200 in accordance with an embodiment of the present invention. The method 200 generally includes the steps of: (a) identifying sensitive data (e.g., target data) 202; (b) establishing monitoring of attempted access to memory locations of target data 204 identified in step (a), (c) executing instructions 206; (d) determining whether an attempt to access target data has occurred (for example, during execution of instructions) 208 using the established monitoring described in step (b); (e) initiating an interrupt upon a determination that an attempt to access target data has occurred 210; (f) invoking data flow analysis 212 in response to the interrupt 212; (g) determining whether the attempted access is legitimate 214; (h) upon a determination that the access is not legitimate, taking appropriate action, such as preventing access and sounding an alarm 216 and/or terminating the offending application 218; (i) upon a determination that the access is legitimate, permitting access 220; and managing target data 222.

In one embodiment, the step of identifying the data of interest includes building a list of target data. This may include a list of all sensitive data that is in within the program data section at initialization and/or a list of the memory locations associated with all sensitive data. An authorized user can indicate which data is sensitive by a variety of means, including software attributes such as pragmas, by a naming rule, or by a separate data list that is read by the monitoring mechanism, which lists the data by symbolic name, by relative or absolute address, or by any other means. Sensitive data input into the system or otherwise arising after initialization, for example, during run time, is added to the target list. Similarly, target data that loses its status as sensitive data can be removed from the list. Some methods for identifying target data are discussed below, but the examples discussed below are merely exemplary and the system may utilize essentially any methodology for identifying target data. Although typical implementations of the present invention may include an explicit list of target data, such as a list of memory locations that contain the target data, the present invention may be implemented with an implicit list. For example, the presence of memory locations in the breakpoint registers may represent a target list. As another example, the contents of a virtual page(s) or a memory segment(s) that is configured to contain only target data may represent a target list.

The system may utilize essentially any monitoring mechanism that is capable of detecting attempted access to a data location and initiating an interrupt or similar event that is capable of pausing the instruction attempting access to the data and triggering validation analysis routines to determine whether to allow the attempted access. Alternatively, instead of pausing an instruction, the system might undo the results of the instruction after it has completed execution, such as cancelling any write operations present in a write buffer before they are performed. The system may use a data breakpoint system to provide this functionality. In one example of this approach, the step of establishing monitoring of all target data includes the step of assigning a separate data breakpoint or data breakpoint register to each memory location containing target data. For example, the system may include routines that assign the memory location of each item of target data on the target data list to a data break point register. In embodiments of this type, the step of invoking the validation analysis mechanism includes the general steps of (a) triggering a data breakpoint interrupt upon attempted access to the target data, (b) pausing execution of the current instruction, (c) invoking an interrupt handler in response to the data breakpoint interrupt, (d) running validation analysis routines to determine whether to permit or prohibit access, and (e) if the access is permitted, allowing the paused instruction to continue execution and complete its access.

The system may also use the memory protection system to provide the data monitoring mechanism, such as virtual paging provided by an MMU or region protection provided by a Memory Protection Unit (MPU), or any hardware device that causes an interrupt for access to memory that is not permitted. In one example of this approach, the process of establishing monitoring of all target data includes the general steps of: (a) assigning each item of target data to one or more region or virtual pages, (b) affecting memory or the memory management unit to ensure a page or permission fault is triggered by access to any target data contained on any region or virtual page, (c) invoking a page or permission fault interrupt handler in response to the fault, (d) determining if the fault relates to attempted access to a target data and (e) upon a determination that the fault is related to attempted access to target data, running validation analysis routines to determine whether to permit or prohibit access. In this embodiment, all target data may be stored separately from non-sensitive data in one or more regions or virtual pages. For example, all target data may be stored in a single virtual page or a single region.

The data monitoring function may be provided by other hardware components capable of monitoring for attempted access to data in essentially any way. For example, in an alternative embodiment, the system may include a logic analyzer or bus monitor that is coupled to the data bus and able to recognize when a memory address for an item of target data appears on the data bus. In one embodiment utilizing a logic analyzer, the step of establishing monitoring of all target data includes the general steps of: (a) operatively coupling a logic analyzer to an interface bus, (b) monitoring via the logic analyzer for attempted access to a memory location containing target data, (c) initiating an event when access to target data is attempted and (d) in response to the event, pausing execution of the current instruction (e.g., the instruction making the attempted access) and running validation analysis routines to determine whether to permit or prohibit access by that instruction. In another embodiment utilizing a bus monitor for an FPGA System on Chip, the step of establishing monitoring of all target data includes the general steps of: (a) instantiating a bus monitor logic block in the FPGA programmable fabric and connecting it to the system interface bus, (b) monitoring via the bus monitor logic for attempted access to a memory location containing target data, (c) initiating an event when access to target data is attempted and (d) in response to the event, pausing execution of the current instruction (e.g., the instruction making the attempted access) and running validation analysis routines to determine whether to permit or prohibit access by that instruction.

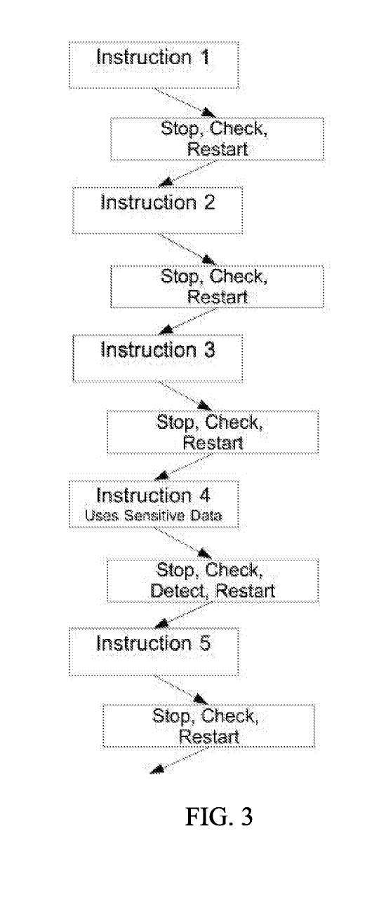

A method of providing validation analysis in accordance with one embodiment of the present invention will now be described. In this embodiment, the method generally uses the two steps of maintaining a list of target/sensitive data and monitoring for attempted access to target/sensitive data on the list. This approach is in contrast to conventional approaches that mark or label the data and monitor for the use of marked data during execution of each instruction (See, e.g., FIG. 3). The approach taken in the present invention improves on conventional system by using a passive technique that reduces the perturbation of the system under measurement. In one embodiment, the present invention maintains a list of the sensitive data (step 1), but drastically reduces the impact of the step 2 (monitor) by configuring the underlying data breakpoint architecture of the processor to flag by use of an interrupt when any usage of the data on the marked list is detected. Rather than active monitoring, the present invention monitors by passive watching, and therefore has very little impact on the behavior of the underlying system being monitored. Rather than watching, by means of inserting additional instructions or by single-stepping and analysis of each instruction, to see if marked data is used (which is the worst case), the present invention watches the data itself (which is the actual case). Because, in many typical applications, the vast majority of instructions do not actually use the marked data, the systems and methods of the present invention are much more efficient and can result in very little perturbation to the system.

The method of the illustrated embodiment includes the step of identifying as target data all sensitive data to be monitored by the system. In this embodiment, sensitive data that is within the program data section at initialization is added to the target list. Similarly, sensitive data received as input to the system during run time is added to target list. In some applications, sensitive data may be identified as target data in advance, for example, by an administrative body. In other applications, data may be analyzed using automated routines to determine whether it is sensitive. For example, data associated with sensitive information stored in or obtained by the computer system may be identified as target data. In the illustrated embodiment, there are a variety of ways that sensitive data can be identified, including but not limited to explicitly identifying by symbol name, by a pattern of names, by associated attributes, or by a set of locations. For data entering the system via an input during run time, there are a variety of ways that sensitive data can be identified, including but not limited to marking a memory location as sensitive representing the incoming input value, or by analyzing incoming messages for certain keywords that flag the data as sensitive. For example, the system may include routines within the I/O device driver responsible for receiving data on an input port to determine whether the new data should be added to the target data list. This determination may be based, for example, on the source of the data (e.g., all data from a specified application, a specified domain or a specified external input may be deemed sensitive), the location at which the data is stored (e.g., all data stored in specified secure domain or range of memory locations may be deemed sensitive), the address from which data was communicated (e.g., certain IP addresses for received Internet communications) and/or the content of the data (e.g., all data containing certain key words, key phrases, patterns or other designated content may be deemed sensitive).

As can be seen, the present invention does not require the data itself to be marked, as is done with many traditional taint analysis systems. Marking the data itself requires changing the program code or the means by which program data is stored. By maintaining an independent, passive list of sensitive data, the present invention reduces the perturbation to the system. An additional advantage is that while traditional taint tracking requires source code, the approach of the present invention does not require source code, as long as the sensitive data can still be identified (e.g., via a symbol table or direct specification of locations).

The system further includes the step of setting up monitoring of all data in the target list. In the illustrated embodiment, the computer data monitoring mechanism(s) are configured to pause execution of program instructions when there is an attempt to access any of the target data, for example, by use of an interrupt. The interrupt handler is configured to invoke the validation analysis mechanism. In this embodiment, the computer data monitoring mechanism(s) may include data breakpoints associated with target data, virtual paging with target data contained on one or more virtual pages, memory protection with target data contained in one or more regions with configurable access permissions, and/or logic analyzer(s) or bus monitors that monitor the data bus for access to target data. In some applications, the most efficient data monitoring mechanism is to utilize data breakpoint registers, sometimes called watchpoint registers. Each register in the set of breakpoint registers can be configured with the location of an item of target data, which causes an interrupt to occur anytime that location is accessed. In operation, a data breakpoint interrupt occurs when there is an attempt to access a data location associated with any of the data breakpoints. Initiation of the data breakpoint interrupt may pause execution of instructions and invoke the data breakpoint interrupt handler. The interrupt handler may include or be configured to invoke validation analysis routines that determine whether or not to permit access to the target data.

If there are more sensitive data items than available data breakpoint registers, an additional data monitoring mechanism can be used to monitor the remaining items by use of the memory protection system, for example, protected memory regions or a virtual paging system. With this approach, the target data may be stored in a region or virtual page and the memory protection or virtual paging system may be configured so each attempt to access target data results in a page fault or permission fault. More specifically, the target data may be stored in a virtual page that is actively managed so that it is available in virtual memory for only a single attempted access. For example, after each access, the virtual paging system may remove from the virtual page from memory or may remove access permission for the region or virtual page from the system managing memory, such as the memory management unit, or memory protection unit, or any other mechanism managing permission for access to memory. As a result, when any access to target data is attempted, the memory management unit generates a page fault or permission fault interrupt. The interrupt handler is configured to determine if the fault is associated with a region or virtual page containing target data. If so, the page fault handle may initiate the data flow analysis mechanism. If the virtual page is removed, each attempted access will result in a hard page fault (e.g., a major page fault). The page fault interrupt handler will cause the virtual page to be rewritten into memory. If access permission is revoked for a virtual page entry from the MMU, a subsequent attempt to access target data on the virtual page may result in a soft page fault (e.g., a minor page fault). A soft page fault does not require the virtual page to be rewritten into memory, but only the entry for that virtual page to be rewritten in the MMU to allow access. If access permission is revoked for memory with access permissions determined by blocks or regions, a permission fault occurs. If the validation analysis determines the access is permitted, the interrupt handler can then restore permissions to allow the current instruction to complete its access.

In some applications, the target data may be intermingled in a memory region or on a virtual page with non-sensitive data. Those accesses which are to the sensitive data contained within the page or region are then analyzed using validation analysis routines (as discussed in more detail below). Those that are not sensitive, proceed as normal (but with a small performance penalty because they were checked). Organizing the data into blocks of sensitive and non-sensitive so that they map to different regions or virtual pages can help reduce the number of checks of non-sensitive data.

In the illustrated data breakpoint embodiment, the system uses an internal mechanism of the processor to monitor for access to target data. Some existing approaches to dynamic data monitoring use a separate processor or separate hardware to monitor computer bus transactions, watching for access to certain memory addresses. However, bus monitoring does not detect processor activity that is cached (so that it never reaches the external bus), and thus will not detect most of the data flows. The method employed by the described data breakpoint embodiment of the present invention detects all data flows of interest. Another distinction is that the described embodiment may use data breakpoints, rather than instruction breakpoints, which other existing dynamic methods use, resulting in much greater perturbation than our approach.

The system may include essentially any validation analysis routine(s) to analyze and determine whether to permit access to target data. As noted above, each time an attempt to access sensitive data (target data) occurs, the data monitoring mechanism is triggered in the computer hardware, causing an interrupt that invokes the validation analysis code. The validation analysis first uses data flow analysis handling code to examine the software program instruction that was interrupted to determine whether that instruction is about to propagate sensitive information. For example, if the instruction was about to perform B=A+1, where A was sensitive data, then the analysis would detect that B is derived from A, and thus sensitive data is about to be propagated.

If sensitive data is about to propagate (i.e., target data is about to flow), then the approval or security handling code determines if this flow is allowed. The system may implement essentially any methodology for determining when to permit access (e.g., when to permit reading of sensitive data, writing to memory location of sensitive data, introducing new data into a secure domain or any other action that might directly or indirectly obtain sensitive data or any information regarding sensitive data, modify sensitive data or potentially introduce or spread taint within a secured domain). In one example, the approval analysis step of validation determines whether to allow access by checking to determine if the data flow crosses the secure domain boundary. If the flow is not allowed (e.g., because it leaves the secure domain), the handling code may also stop the program that attempted the access because it is violating the security policy. The system may also raise an alarm (e.g., notifies an authorized user of the illicit flow). The handling code could raise an alarm in a variety of ways, including, but not limited to halting the monitored program, signaling an authorized user via a message, invoking an independent security violation handling program, or triggering a computer output (such as an audible alarm sound). These examples are not intended to an exhaustive list and the system may be configured to take essentially any desired action. If data flow analysis routine determines that the data flow is allowed (e.g., because the target data does not leave the secure domain), then the system may allow the instruction to be executed and the data to be accessed.

The validation analysis mechanism may implement a wide variety of alternative methodologies for determining whether to permit access. For example, in an alternative embodiment the system may be configured to allow sensitive information to leave the secure domain only if via an authorized interface (which would be specified in advance, e.g., by memory location) or by encrypting it before crossing the perimeter defined by the secure domain. With this alternative embodiment, encryption of data could appear to the data flow analysis algorithm as derived data, which normally would then still be flagged when it crossed the security perimeter. So in this case, the approval step of the validation analysis algorithm would be augmented to identify the program code associated with the encryption and treat this new data as underived (non-sensitive). Similarly, incoming encrypted data that arrived in the secure domain and was decrypted would then be treated as new sensitive data received on an input.

As noted above, the system may also be configured to dynamically manage the target data list during run time. This may include adding new target data the list as it is created and removing old target data from the list when it is eliminated. In the illustrated embodiment, new data can be added to the target list in various ways. If the validation analysis routine determines that the flow is allowed (e.g., because the target data does not leave the secure domain), any new derived data locations may be added to the target list and monitoring of those new locations may configured. In the context of a data breakpoint implementation, establishing monitoring of new derived data may include assigning or associating a data breakpoint with the memory location of the new derived data. In the context of a memory protection or virtual paging implementation, this may include adding the new derived data to a region or virtual page associated with target data. Old target data may be removed from the target list if it is no longer sensitive. For example, when target data is overwritten by data that is not sensitive and not derived from sensitive data, then the overwritten location is no longer sensitive and could be removed. The validation analysis mechanism can invoke this potential clean-up of old target data each time it detects a write access to data on the target list.

The system may implement any desirable method for determining when to remove target data from the target data list. For example, the system may use static data flow analysis, for example live variable analysis, to determine the scope (lifetime) of each sensitive data item, then instrumenting the code at the end of life point so that it is removed from the target list. Any region or virtual page of data memory that is discarded can be checked first, and if it contains any sensitive data, those items can be removed from the target list. If sensitive data is overwritten with non-sensitive data, then the handling code removes that data from the target list and stops monitoring it. It is typically considered good programming practice for programs to zeroize sensitive data (i.e., overwrite with the value 0) when the data is no longer needed, and thus this step would be triggered by the monitoring mechanism upon the attempt to write, thus keeping the target list to a manageable size.

### Example

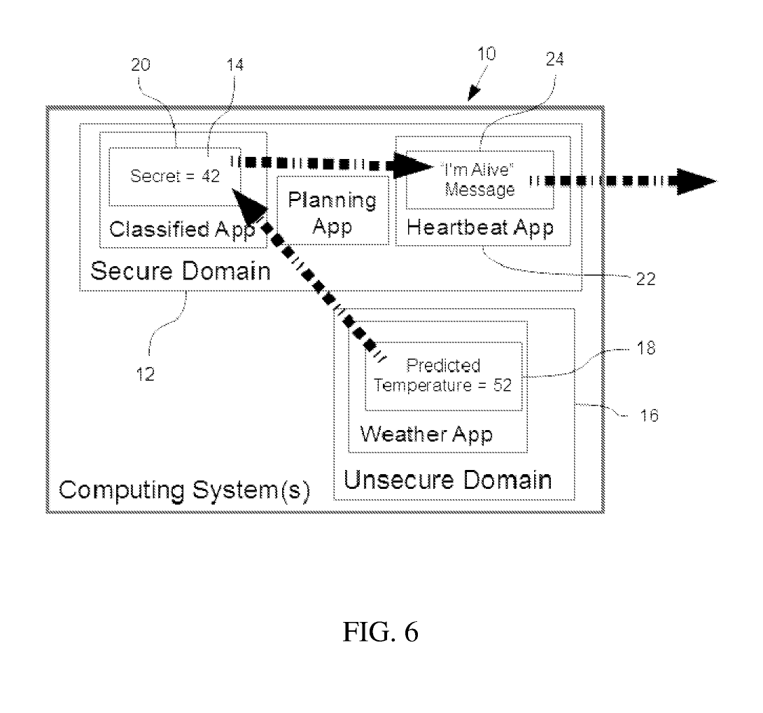

As an example, consider a computing system running four application software programs. A secure domain is defined to contain three of the applications: a classified app containing a secret code word, a planning app, and a heartbeat app that sends out a simple message to indicate the system is operating normally. A second domain is defined that contains the fourth software program: a weather forecasting app. FIG. 5 illustrates data flows that could occur in the system that would be defined as authorized. The data flow monitoring mechanism would put the secret=42 data on a sensitive target list for monitoring, to ensure this data (or any data derived from it) did not flow out of the secure domain. The data flow monitoring mechanism would also put the predicted Temperature=52 on a tainted target list for monitoring, to ensure this data (or any data derived from it) was never mingled with data on the sensitive data (because it comes from an untrusted app and thus could be corrupted). FIG. 6 then illustrates some of the unauthorized data flows that could be detected and prevented. For example, if the software ever attempted to combine the forecasted temperature data 18 with the secret data 20, the access to these data items would trigger the monitoring mechanism and raise an alarm. As another example, if the heartbeat app 22 ever attempted to combine the secret data 20 with the “I'm Alive” message 24, the access to these data items would trigger the monitoring mechanism and raise an alarm.

In the embodiments describe above, the hardware is configured to identify all attempts to gain knowledge about the target data (e.g., by reading or writing it). The hardware mechanism to monitor for these attempts can include approaches such as:
Data breakpoint CPU registers (also known as watchpoint registers), which cause a data breakpoint interrupt when the specified locations are about to be accessed by the currently executing instruction
Virtual paging system, managed by the Memory Management Unit (MMU) via the Translation Lookaside Buffer (TLB) and page tables, which causes a page fault interrupt when the specified pages of virtual memory are about to be accessed
Memory protection systems, managed by a Memory Protection Unit (MPU) with registers or tables to define access permissions to each defined block or region of memory, which causes a permission fault interrupt when the specified blocks or regions of memory are about to be accessed.
A logic or bus analyzer connected to the computer system bus and configured to send an interrupt signal to the computer when a specified address is found on the address bus
A bus monitoring logic module connected to the system bus in a System On Chip and configured to send an interrupt signal to the processor when a specified address is found on the address bus connecting the processor to the memory where sensitive data is stored.
   However, it should be understood that these examples are for illustration purposes only and not intend to limit the scope of the present invention. Any other computer component or similar mechanism that can be configured to monitor access to data may provide an alternative mechanism for implementing the present invention.

In the illustrated embodiment, the hardware and software is configured to identify all attempts to gain knowledge about the target data. In this embodiment, the system identifies the target data by its address. Normally this is an address within the memory system. However, if the processor system has other ways to store data, such as I/O ports with a separate addressing space from memory, then those addresses can also be added to the target list (along with notation to indicate which address space). Alternatively, the list of target data could be indirect references, such as a symbol name that is then mapped to a particular location, or a pointer value that is dereferenced to determine the actual address of the target data. The present invention may be configured to monitor any computer component that makes the attempt to access target data (e.g., by reading or writing), including without limitation: any CPU in the system; any CPU core of each multicore processor in the system; Direct Memory Access (DMA) devices, which have the ability to read from or write to addresses where data is stored; I/O devices that have the ability to read rom or write to addresses where data is stored (e.g., DMA capability); and any of these components that access data stored in a multiport memory by any port, using any address that is associated with the target data. If the system includes any computer component that cannot be configured to detect and pause an attempt to gain knowledge about the target data, then those components are configured so that they do not have access to the target data. The present invention is not limited to the specific methods of data access described herein. Instead, the present invention may be configured by software to monitor with a hardware mechanism, and optionally augmented with software monitoring, for any activity of the computer system that gains knowledge about data located at a certain address without directly operating on it or alters the value of data located at a certain address without directly operating on it, or if this is not possible, then the present invention can resort to either prohibiting that activity or use the traditional method of stopping execution of the software on each use of that activity.

As discussed above, the present invention may include routines to dynamically manage the list of target data during run time. Once an attempt is made to gain knowledge about the target data (e.g., through reading or writing its address), the present invention may implement traditional data flow analysis to determine whether the software operation that is about to attempt the access will propagate the data to new addresses. The term “propagate” is intended to be broadly interpreted to encompass essentially any action or operation having a result that is, in whole or in part, a function of the target data or is in any way derived from the target data (through any type of operation where the result is dependent on or derived from the target data). For example, any machine code operation that uses the target data as a source might propagate that data. There is a wide range of existing data flow analysis methods that may be incorporated into the present invention to allow the system to recognize any potential propagation of target data. As a result, a detailed description of data flow analysis is not provided. However, as noted above, suitable examples include analysis of assembly or register transfer language, control flow analysis, available expression analysis, parse tree analysis, interprocedural analysis, definite assignment analysis, and live variable analysis. These specific examples are merely exemplary and may be replaced by essentially any desired data flow analysis methods.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A system for monitoring flow of target data within a computer system comprising:
a secure domain within the computer system;
data storage associated with said secure domain, said data storage having a plurality of data locations associated with the target data; and
a computer data monitor configured to trigger based on attempted access to any one of said data locations associated with said target data and to invoke a validation mechanism upon said attempted access, said validation mechanism including a data flow analysis routine to determine a potential flow of said target data and a security analysis routine configured to permit or prohibit said attempted access dependent on the outcome of said data flow analysis routine.

2. The system of claim 1 wherein said computer data monitor is configured to generate an interrupt upon any attempted access to any of said data locations.

3. The system of claim 2 wherein said computer data monitor includes an interrupt handler capable of invoking said validation mechanism, including said data flow analysis routine and said security routine.

4. The system of claim 3 wherein said computer data monitor includes at least one data breakpoint associated with a data location of an item of target data, said breakpoint configured to generate an interrupt in response to any attempted access to said data location of said item of target data.

5. The system of claim 3 wherein said computer data monitor includes a plurality of data breakpoints uniquely associated with a plurality of data locations for a plurality of items of target data, each of said breakpoints configured to generate an interrupt in response to any attempted access to any of said data locations of said plurality of items of target data.

6. The system of claim 3 wherein said computer data monitor includes a memory management system in which at least one of said items of target data is stored in a memory segment managed by said memory management system; and
wherein said memory management system is configured to generate an interrupt upon an attempted access to said memory segment storing said item of target data, said interrupt invoking said validation mechanism.

7. The system of claim 3 wherein said computer data monitor includes a virtual memory system having a memory management unit configured to generate a page fault upon any attempted access to a virtual page containing at least one of said items of target data.

8. The system of claim 7 further including a virtual page management routine configured so that each attempted access to said virtual page results in a page fault until permitted by said validation mechanism.

9. The system of claim 8 wherein said virtual page management routine is configured to remove said virtual page from memory after each attempted access or to remove access permissions for the virtual page entry after each attempted access.

10. The system of claim 1 further including a data propagation routine configured to add to the target data any data that is introduced into said data storage during run time.

11. The system of claim 1 further including a data propagation routine configured to add to the target data any data that is derived from the target data during run time.

12. The system of claim 1 wherein said computer data monitor includes a logic analyzer associated with a bus for said data storage, said logic analyzer configured to generate an event upon any attempted access to any of said data locations.

13. A method of configuring computer data monitoring mechanisms to detect access to or modification of target data, comprising the steps of:
establishing a monitoring mechanism to trigger upon detection of attempted access to target data in memory rather than on execution of each general instruction;
once the monitoring mechanism is triggered, performing data flow analysis on the attempted access to determine propagation of the target data associated with the attempted access;
determining whether the attempted access is authorized or unauthorized;
if authorized propagation of data is detected, permitting the attempted access to proceed; and
if unauthorized propagation of data is detected, then prohibiting the attempted access.

14. The method of claim 13, wherein the data monitoring mechanism includes at least one of data breakpoint register configured with a location of an item the target data.

15. The method of claim 13, wherein the data monitoring mechanism includes a memory management system having at least one memory segment containing at least one item of target data, the data monitoring mechanism configured to cause an interrupt on attempted access to the memory segment containing the at least one item of target data; and
wherein occurrence of the interrupt triggers the monitoring mechanism.

16. The method of claim 13, wherein the system includes a list of target data that is generated by examining source code.

17. The method of claim 13, wherein a list of target data is generated without access to source code by specifying a list of data locations that are sensitive.

18. The method of claim 13, wherein a list of target data is generated by specifying data symbols that can be found in a symbol table.

19. The method of claim 13, wherein new entries are added to a list of target data to add locations for target data entering a computer system via one or more specified input ports.

20. The method of claim 13, wherein new entries are added to a list of target data to add locations for data derived from target data during execution.

21. The method of claim 13, further including the step of raising an alarm when unauthorized propagation of data is detected.

22. The method of claim 21 wherein said step of raising an alarm includes at least one of halting a monitored program that caused the attempted access, asserting an electronic signal indicative of unauthorized propagation, and communicating a message.

23. The method of claim 13, wherein the data flow analysis is configured to detect an authorized propagation when the attempted access will cause an item of target data to flow through an authorized interface.

24. The method of claim 13, wherein the data flow analysis is configured to detect an unauthorized propagation when the attempted access will case an item of target data to flow through an unauthorized locations or an unauthorized interface.

25. The method of claim 13, wherein the data flow analysis is configured to detect an authorized propagation when an item of target data is encrypted.

26. A method comprising:
identifying data of interest within a set of programs running on a computer, without modifying the program data or the program code;
maintaining a target list of memory locations of the data of interest; and
configuring computer data monitoring mechanisms to detect attempted access to any memory location on the target list where the mechanisms trigger upon attempted access to the memory location rather than on execution of each general instruction.

27. The method of claim 26 further including the step of performing validation analysis only when attempted access to data of interest is detected by the computer data monitoring mechanism.

28. The method of claim 26 further including the steps of:
detecting propagation of data of interest during run time; and
adding a memory location of derived data to the target list.

29. The method of claim 26 further including the steps of:
detecting data intrusion or extrusion of data of interest; and
upon detection of data intrusion or extrusion, raising an alarm.

30. The method of claim 27 wherein the step of performing validation analysis includes the steps of performing data flow analysis of the attempted access and performing security analysis of the attempted access.
